(19) United States
(12) Patent Application Publication
(10) Pub. No.: US 2007/0119645 A1
(43) Pub. Date: May 31, 2007

(54) Motorcycle Drive Shaft Offset Assembly

(76) Inventor: William M. Michelotti, Stamford, CT (US)

Correspondence Address: ST. ONGE STEWARD JOHNSTON & REENS LLC, 986 Bedford Street, Stamford, CT, 06905-5619, US

(21) Appl. No.: 11/564,006

(22) Filed: Nov. 28, 2006

Related U.S. Application Data
(60) Provisional application No. 60/740,917, filed on Nov. 30, 2005.

(51) Int. Cl. B62D 61/02

(52) U.S. Cl. 180/219

(57) ABSTRACT

A power transmission assembly for transmitting rotational torque from a motorcycle engine to an oversized rear wheel of a motorcycle, the assembly including a front drive shaft, an intermediate offset power transmission assembly and a rear drive shaft, all provided in a motorcycle swingarm. +The intermediate offset power transmission assembly allows for the rear drive shaft to be axially offset relative to the front drive shaft so as to position the rear drive shaft outboard of the oversized rear wheel.

### CROSS-REFERENCE TO RELATED APPLICATIONS

This application claims the benefit of the filing date of U.S. Provisional Patent Application Ser. No. 60/740,917 filed Nov. 30, 2005.

### FIELD OF THE INVENTION

The invention relates to power transmission assemblies in motorcycles and more specifically to a power transmission shaft for transmitting rotational torque to a rear wheel of a vehicle.

### BACKGROUND OF THE INVENTION

Motorcycles and two-wheeled vehicles are typically equipped with standard equally sized front and rear wheels. It is however, a popular pastime among motorcycle enthusiasts to alter their motorcycles with customizations, such as paint and/or structural modifications. A popular custom feature is the installation of an oversized rear wheel. One such custom modification is to provide an oversized rear wheel having a width which is wider than the original equipment manufacturer wheel. Installation of an oversized tire adds to the aesthetic appearance of the motorcycle.

However, installation of an oversized rear wheel presents a number of challenges, most particularly, in routing power from the transmission to the oversized rear wheel. There are two principle drive designs in use in motorcycles: (1) belt or chain drives found on many Harley-Davidson® motorcycles, and (2) shaft drive assemblies found on motorcycles such as the Honda® Aero 750 and the BMW® K11200S. Several designs have been presented for routing power to a rear wheel in belt or chain drive motorcycles retrofitted with an oversized rear wheel, such as those disclosed in U.S. Pat. Nos. 6,755,272 and 6,575,260.

However, with shaft-driven designs, the problem of transferring torque to a wider rear wheel becomes exceptionally difficult as the oversized rear wheel will block the path of the drive shaft to the rear drive coupling. Therefore, the previously known systems for accommodating and oversized rear wheel cannot be used in a shaft drive assembly.

### SUMMARY OF THE INVENTION

What is desired therefore is a system and method for transmitting driving torque to the rear wheel of a shaft drive motorcycle, where the rear wheel is provided as an oversized wheel.

It is further desired to provide a system and method for retrofitting a motorcycle with an oversized rear wheel that accommodates the drive shaft assembly of the motorcycle.

It is still further desired to provide a system and method that provides a reliable, simply design for repositioning the drive shaft of a motorcycle to a position outboard of an oversized rear wheel.

These and other objects are achieved in one advantageous embodiment by the provision of an intermediate offset power transmission assembly and rear drive shaft.

The drive shaft of a standard motorcycle typically extends rearward toward an outboard position adjacent to the rear wheel of the motorcycle. The drive shaft is designed to engage with a wheel having a particular width, typically the same width as the front wheel. However, when an oversized wheel (a wheel having an increased width) is used, the drive shaft provided from the factory extends into the oversized wheel.

The present invention provides a front drive shaft coupled to one end of an intermediate offset power transmission assembly which is in turn coupled to a rear drive shaft which transmits output torque to the oversized rear wheel. The intermediate offset power transmission assembly transmits rotational torque input from the front drive shaft to the rear drive shaft, which is longitudinally offset from the front drive shaft. The intermediate offset power transmission assembly is provided to longitudinally offset a portion of the drive shaft to a position that is outboard of the oversized rear wheel. The axis of the front drove shaft is offset from the axis of the rear drive shaft so that the two shafts may be considered axially offset relative to each other. The intermediate offset power transmission assembly may comprise torque transmission devices including, for example, chain and sprocket drives, belt drives, a gear set, or even a hydraulic drive system. The front drive shaft, intermediate offset power transmission assembly, and rear drive shaft are built into the swingarm of the motorcycle rear wheel and serve as the left side of the swingarm.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the present invention.

FIG. 2 is a block diagram of the intermediate offset power transmission assembly according to FIG. 1.

FIG. 3 is an illustration of an advantageous embodiment of the present invention according to FIG. 1.

FIG. 4 is an exploded view of the advantageous embodiment according to FIG. 3.

FIG. 5 is a top view of the advantageous embodiment according to FIG. 3.

### DETAILED DESCRIPTION OF THE INVENTION

Referring now to the drawings, wherein like reference numerals designate corresponding structure throughout the views.

The present assembly allows for retrofitting of a wider rear wheel onto an existing motorcycle frame. The retrofitting process includes replacing the existing swingarm with the swingarm 121. While a particular sized rear wheel is illustrated, many different sized wheels may effectively be used with the assembly. The wider oversized rear wheel 112, the longer elongated housing 118 must be to position rear drive shaft 106 outboard of the wheel. It is contemplated that a number of standard sized housing may be made to coincide with standard wheel widths.

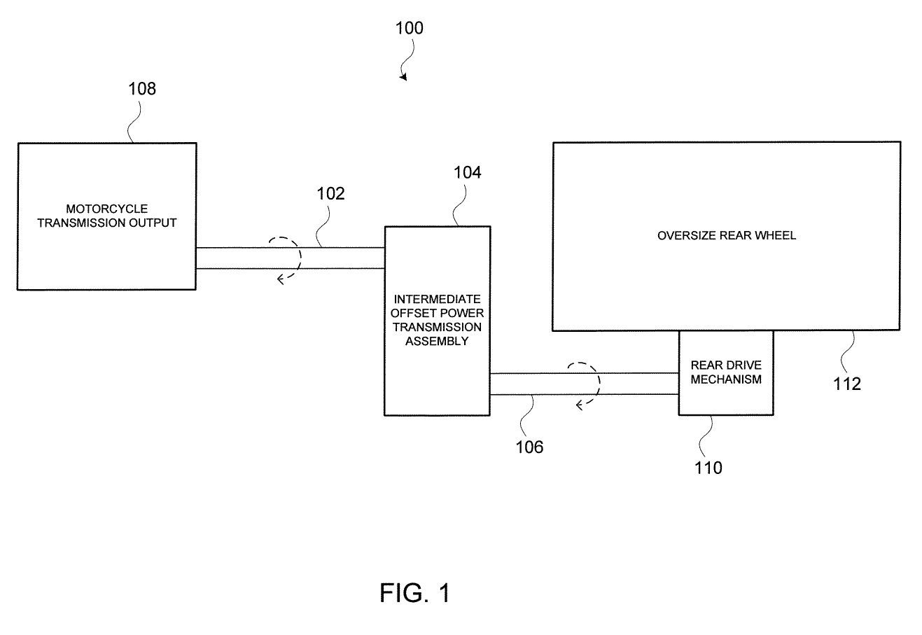

FIG. 1 is a block diagram depicting power transmission assembly 100. Power transmission assembly 100 generally comprises, front drive shaft 102, intermediate offset power transmission assembly 104 and rear drive shaft 106. As shown in FIG. 1, front drive shaft 102 is located after the motorcycle engine torque output and the transmission output 108 and extends to the intermediate offset power transmission assembly 104. Front drive shaft 102 is provided to transmit rotational torque from the motorcycle engine/transmission assembly to the intermediate offset power transmission assembly 104. Rear drive shaft 106 receives rotational torque from intermediate offset power transmission assembly 104 and transmits the torque to oversized rear wheel 112. Rear drive shaft 106 extends from the intermediate offset power transmission assembly 104 to a rear drive mechanism 110. Rear drive mechanism 110 is typically a ring gear or bevel gear mechanism transferring power from the rear drive shaft 106 to oversized rear wheel 112.

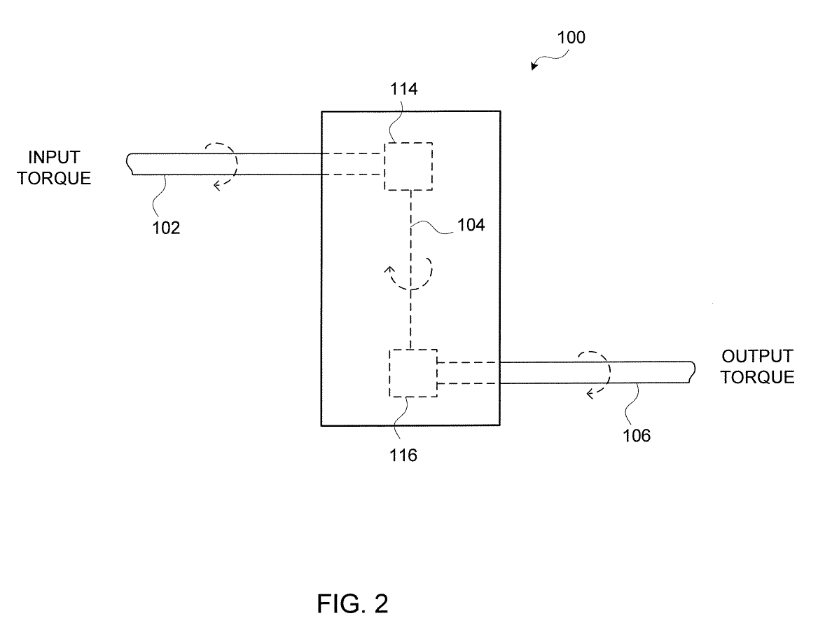

Turning now to FIG. 2, intermediate offset power transmission assembly 104 is shown in greater detail. Intermediate offset power transmission assembly 104 couples rotational torque from front drive shaft 102 to rear drive shaft 106. The intermediate offset power transmission assembly 104 allows the drive shaft extending from the motorcycle engine to be axially offset to an outboard position relative to oversized rear wheel 112. In this manner, a standard OEM rear wheel, which is much thinner and substantially aligns with the longitudinal axis of front drive shaft 102, may be replaced with an oversized wheel. Intermediate offset power transmission assembly 104 is provided to transmit rotational torque to longitudinally offset shaft members. Intermediate offset power transmission assembly 104 may comprise a number of differing power transfer mechanisms including for example offset sprockets connected by an endless chain loop, or pulley members connected by an endless belt loop, or cogged pulleys connected by a cogged belt, or a gear set, or a hydraulic power transmission assembly using vaned turbines mounted on the front and rear drive shafts. Most preferably the power transfer mechanism contains two parallel power transfer mechanisms, for example, two sets of sprocket/chain combinations or two sets of pulley/belt combinations.

FIG. 2 further contains an interface 114 for interfacing front drive shaft 102 with intermediate offset power transmission assembly 104. Additionally, interface 116 provides an interface between intermediate offset power transmission assembly 104 and rear drive shaft 106. It is contemplated that interface 114, 116 may comprise one or more parts, including for example, bushings, washers, nuts, spacers, connectors, and the like for coupling the drive shafts to the intermediate offset power transmission assembly 104.

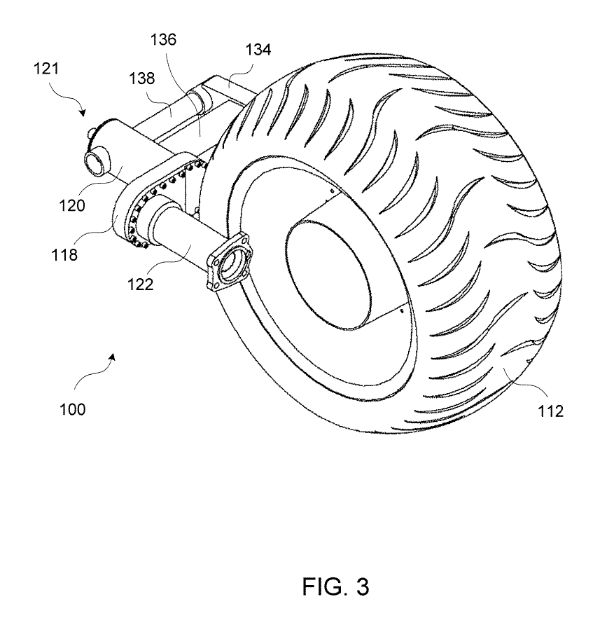

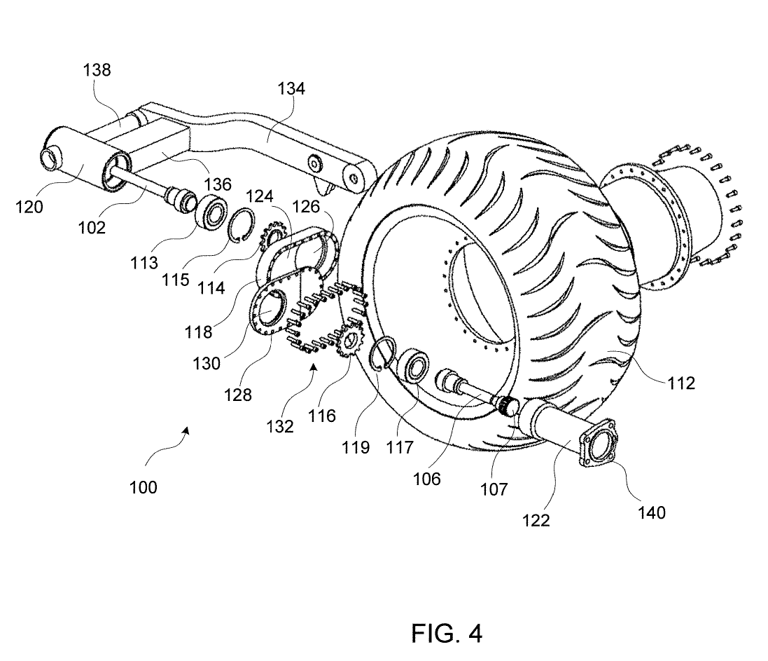

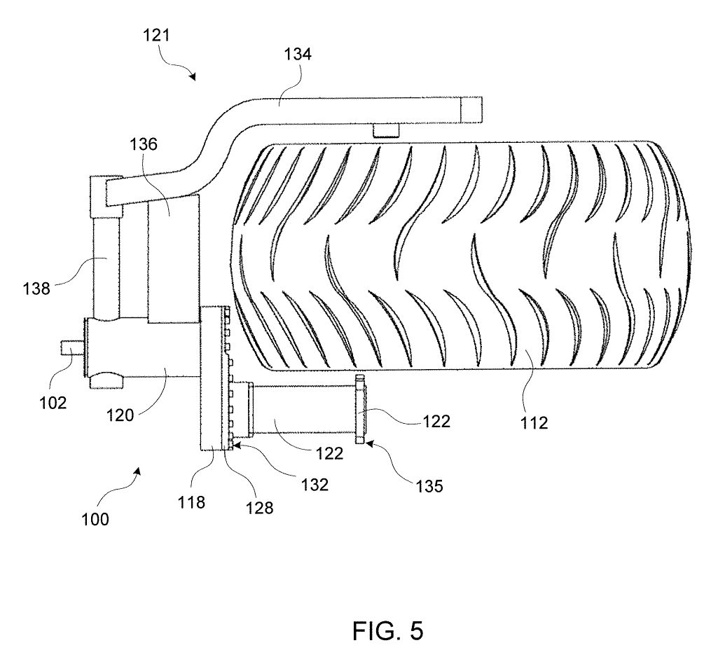

Referring now to FIGS. 3-5, a perspective exterior view of power transmission assembly 100 is shown in FIG. 3, while a top view is shown in FIG. 5. Power transmission assembly 100 is integrated in the swingarm 121 having a pivot tube 138, which couples to the motorcycle frame (not shown) and allows the assembly to pivot with respect to the motorcycle frame. The pivoting swing arm 121 hold the axle of the rear wheel but pivots vertically to allow the suspension to absorb bumps in the road. The right arm 134 of swingarm 121 extends outboard of oversized rear wheel 112 on the side opposite to the drive shaft side, as seen in FIGS. 4 and 5. Oversized rear wheel 112 is driven by the drive shaft extending along the left arm 135 on the left side of the swingarm 121. While the drive shaft is illustrated on the left side of oversized rear wheel 112, it is contemplated that the drive shaft may also be positioned on the right side of oversized rear wheel 112 in some applications. The right arm 134 has a substantial offset to accommodate the oversized rear wheel 112, however, other different configurations and shapes may effectively be used. As can further be seen in FIGS. 3-5, swingarm 121 includes the front shaft cover 120 and a support member 136, which provides a robust coupling for the left and right sides of the swingarm 121.

Front drive shaft 102 is coupled to the motorcycle engine by way of a motorcycle transmission. As best seen in FIG. 4, front drive shaft 102 is contained in front shaft cover 120. Front shaft cover 120 is welded or otherwise affixed to front wall 124 of an elongated housing 118 in which intermediate offset power transmission assembly 104 is located. An opening 126 is located in the front wall 124 and front drive shaft 102 extends into elongated housing 118. Elongated housing 118 extends perpendicularly to front shaft cover 120 and rear shaft cover 122. Bearing 113 and circlip 115 center the front drive shaft 102 in the opening 126. Sprocket 114 is located at the rear end of the front drive shaft 102 and is positioned within the elongated housing 118. A rear cover 128 for elongated housing 118 is detachably affixed to housing 118 by means of screws 132 or other attachment devices. Rear cover 118 has an opening 130 and the front end of rear drive shaft 106 extends through the opening. Bearing 117 and circlip 119 center the rear drive shaft 106 in the opening 130. Sprocket 116 is located at the front end of the rear drive shaft 106 and is positioned within the elongated housing 118. Sprockets 114 and 116 are connected by a loop of chain so that power received by the front drive shaft 102 is transferred to the rear drive shaft 106. Rear drive shaft 106 is contained in rear shaft cover 122. Rear shaft cover 122 is has a flange 140, which is provided to interface with a rear drive mechanism 110 (shown schematically in FIG. 1). The rear drive mechanism 110 is a driven flange assembly such as the mechanism disclosed in U.S. Pat. No. 6,516,912, the disclosure of which is incorporated by reference. The gear end 107 at the rear of rear drive shaft 106 transfers power to the rear drive mechanism 110 to drive the oversized rear tire via a driven flange.

It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein. Although the invention has been described with reference to a particular arrangement of parts, features and the like, these are not intended to exhaust all possible arrangements or features, and indeed many other modifications and variations will be ascertainable to those of skill in the art.

What is claimed is:

1. A power transmission assembly for a motorcycle comprising:
a front drive shaft coupled to an engine, said front drive shaft receiving rotational torque generated by the engine;
a rear drive shaft coupled to a rear wheel of the motorcycle, said rear drive shaft transmitting rotational torque to the rear wheel;
an intermediate offset power transmission assembly coupled between said front drive shaft and said rear drive shaft, said intermediate offset power transmission assembly transmitting the rotational torque from said front drive shaft to said rear drive shaft;
said front drive shaft coupled to a first end of said intermediate offset power transmission assembly and said rear drive shaft coupled to a second end of said intermediate offset power transmission assembly such that said front drive shaft is axially offset from said rear drive shaft.

2. The power transmission assembly according to claim 1 wherein said intermediate offset power transmission assembly comprises a loop driven material coupled between said front drive shaft and said rear drive shaft.

3. The power transmission assembly according to claim 2 wherein said loop driven material comprises one or more belts connecting pulleys mounted to said front drive shaft and said rear drive shaft.

4. The power transmission assembly according to claim 2 wherein said loop driven material comprises one or more chains connecting sprockets mounted to said front drive shaft and said rear drive shaft

5. The power transmission assembly according to claim 1 wherein said intermediate offset power transmission assembly comprises a gear set connecting said front drive shaft and said rear drive shaft.

6. The power transmission assembly according to claim 1 further comprising a rear drive mechanism operably connecting said rear drive shaft to the rear wheel.

7. The power transmission assembly according to claim 1 wherein said intermediate offset power transmission assembly comprises an elongated housing.

8. A motorcycle drive shaft offset assembly, comprising:
a swingarm having two spaced apart arms spaced apart to receive an oversized rear wheel between them; said swingarm having a power transmission assembly provided in one said arm, said power transmission assembly having a rearwardly extending front shaft cover containing a front drive shaft, and rear shaft cover containing a rear drive shaft, said front shaft cover and rear shaft cover being longitudinally offset from each other to position said rear shaft cover outwardly adjacent to said oversized rear wheel, and an housing extending perpendicularly to said front shaft cover and rear shaft cover containing an intermediate offset power transmission assembly operably connecting said front drive shaft and rear drive shaft,
a rear drive mechanism operably connected to a rear end of said rear drive shaft and driven thereby, said rear drive mechanism being operably connected with said oversized rear wheel.

9. The motorcycle drive shaft offset assembly of claim 8 wherein said intermediate offset power transmission assembly comprises a loop driven material coupled between said front drive shaft and said rear drive shaft.

10. The motorcycle drive shaft offset assembly of claim 9 wherein said loop driven material comprises one or more belts connecting pulleys mounted to said front drive shaft and said rear drive shaft.

11. The motorcycle drive shaft offset assembly of claim 9 wherein said loop driven material comprises one or more chains connecting sprockets mounted to said front drive shaft and said rear drive shaft

12. A method for transmitting torque from a motor to an oversized rear wheel of a shaft driven motorcycle comprising the steps of:
operably connecting a first end of a front drive shaft to a transmission and engine of a motorcycle;
generating rotational torque with the engine and transmitting the torque to the front drive shaft;
coupling a second end of the front drive shaft to a first end of an intermediate offset power transmission assembly;
coupling a first end of a rear drive shaft to a second end of the intermediate offset power transmission assembly such that the rear drive shaft is axially offset from the front drive shaft;
transmitting the rotational torque from the front dive shaft through the intermediate offset power transmission assembly to the rear drive shaft; and
coupling the rear drive shaft to the rear wheel and transmitting the rotational torque to the oversized rear wheel.

13. The method according to claim 12 wherein the intermediate offset power transmission assembly includes a loop driven material coupled between the front drive shaft and the rear drive shaft.

14. The method according to claim 13 wherein the loop driven material is selected from the group consisting of: a belt, a chain and combinations thereof.

15. The method according to claim 13 wherein the loop driven material is a double loop material.

16. The method according to claim 12 wherein the intermediate offset power transmission assembly includes gearing coupled between the front drive shaft and the rear drive shaft.

17. A method for retrofitting an oversized rear wheel onto a shaft driven motorcycle comprising the steps of:
removing an existing rear wheel of a motorcycle;
removing an existing swingarm of said motorcycle;
installing a retrofit swing arm, said retrofit swing arm including two spaced apart arms spaced apart to receive an oversized rear wheel between them; said swingarm having a power transmission assembly provided in one said arm, said power transmission assembly having a rearwardly extending front shaft cover containing a front drive shaft, and rear shaft cover containing a rear drive shaft, said front shaft cover and rear shaft cover being longitudinally offset from each other to position said rear shaft cover outwardly adjacent to said oversized rear wheel, and an housing extending perpendicularly to said front shaft cover and rear shaft cover containing an intermediate offset power transmission assembly operably connecting said front drive shaft and rear drive shaft,
engaging a front end of said front drive shaft to a motorcycle transmission output;
engaging a rear end of said rear drive shaft with a rear drive mechanism, said rear drive mechanism being operably connected with said oversized rear wheel.
